(19) United States
(12) Patent Application Publication
(10) Pub. No.: US 2008/0071736 A1
(43) Pub. Date: Mar. 20, 2008

(54) APPARATUS, SYSTEM, AND METHOD FOR CRITERIA-BASED GROUPING AND SEARCHING OF DATABASE MANAGEMENT SYSTEM LOG RECORDS

(76) Inventor: Alan Ray Smith, Gilroy, CA (US)

Correspondence Address: Kunzler and Associates;David J. McKenzie, Suite 600, 8 East Broadway, Salt Lake City, UT, 84111, US

(21) Appl. No.: 11/470,203

(22) Filed: Sep. 5, 2006

(51) Int. Cl. G06F 17/30

(52) U.S. Cl. 707/3

(57) ABSTRACT

An apparatus, system, and method are disclosed for criteria-based grouping and searching of database management system log records. The method performs criteria-based grouping and searching of database management system log records by: interpreting a search criteria; interpreting a log record data description; extracting a plurality of log records from a set of database management system log records according to the search criteria and the log record data description; generating intermediate information configured to allow a sort utility to sort the extracted log records; sorting the extracted log records according to the search criteria; and presenting the sorted extracted log records to a user. The method allows users to quickly sort and review log files according to desired criteria at review time, rather than the sorting criteria used to store the log files at the time of creation.

### BACKGROUND OF THE INVENTION

1. Field of the Invention

This invention relates to searching of database management system log records, and more particularly relates to searching database management system log records according to user-specified criteria.

2. Description of the Related Art

Database management systems, for example Information Management System (IMS) from IBM, generate log records of transactions and various other events that occur on the system. Such log records are typically recorded in chronological order, while various information within a record—for example what database is being accessed—may occur in any field or location within the record according to the type of log record being recorded. Chronological order is sometimes useful for a reviewer if the reviewer is looking for a log record related to an event at a certain time of day. However, often a reviewer wishes to see all of the log records organized by some other criteria; for example the reviewer may wish to see all of the log records related to a particular resource (e.g. a user, program, transaction, or database). Further, a log record set for a large system in a single day may contain thousands of log records, many of which do not contain the type of information that the reviewer is interested in. Pulling log records having a particular field may present all of the log records having the specified field. However, due to the chronological ordering of the log records and limitations of the conventional query tools, the records having different values for the particular field are intermixed and unordered. This intermixed result set can complicate analysis of the results where the analyst desires to review log records based primarily on the resource or event responsible for having the log record generated.

Sorting utilities that order records in a database based upon a specified data field are well known. However, presently utilized search utilities do not order records where the criteria for sorting the records do not occur in the same data field for each record. The problem is even more acute in database applications which generate records based on one set of criteria, and which will later be evaluated for a different set of criteria. The evaluation criteria may not be known at the time the record set is generated, and therefore the location of the evaluation criteria may vary within log records. In the context of database management systems, current search utilities cannot narrow the log record to the log entries of interest to the reviewer, ensure that all records of interest can be extracted from a log record, or sort the log record based on the data of interest to the reviewer.

From the foregoing discussion, it should be apparent that a need exists for an apparatus, system, and method for grouping and sorting database records based on a set of criteria. The apparatus, system, and method should allow grouping and sorting of records where the data of interest may not be stored in the same field location for all records. Beneficially, the apparatus, system, and method should allow grouping and sorting of log records in a database management system.

### SUMMARY OF THE INVENTION

The present invention has been developed in response to the present state of the art, and in particular, in response to the problems and needs in the art that have not yet been fully solved by currently available business event monitoring systems. Accordingly, the present invention has been developed to provide a computer programmed product and method for criteria-based searching of database records that overcome many or all of the above-discussed shortcomings in the art.

An apparatus is provided with modules to functionally execute criteria-based searching of database records. The apparatus may comprise a search criteria module, a log map module, a record extraction module, an intermediate information module, a sorting module, and a record display module.

The search criteria module may be configured to interpret a search criteria. The search criteria may comprise a log field label. In one embodiment, the search criteria may indicate that the records of interest comprise records containing a field with a label equal to the search criteria. The log field label may comprise a database name, a program name, a transaction name, or a user name. In a further embodiment, the search criteria may also indicate that the records of interest should be sorted according to the field indicated by the search criteria. The search criteria may further comprise a partial log field label, multiple log field labels, a log field label with a partial value, and combinations thereof.

The log map module may be configured to interpret a log record description, which may be a data map. The log record description may comprise at least one log record type, a set of log field labels corresponding to each log record type, and a set of log field label locations corresponding to each of the set of log field labels. The log record description may be a file comprising a set of log record types, a set of log field labels corresponding to each of the set of log record types, and a set of data field locations corresponding to each of the set of log field labels.

The record extraction module may be configured to extract a plurality of log records from a set of log records according to the search criteria and the log record description. In one embodiment, the record extraction module may be configured to extract log records having a data field with a label equivalent to the search criteria according to the log record description.

The intermediate information module may be configured to generate a sort handle configured to allow a sorting utility to sort the extracted log records according to the search criteria. For example, the intermediate information module may be configured to append a data field at the beginning of each of the extracted records, wherein the data field comprises the data values corresponding to the log field labeled according to the search criteria. The sort handle may comprise a data field appended to the extracted records with the inserted information. The intermediate information module may be further configured to generate intermediate information comprising a file, an internal data array, or similar storage articles, the intermediate information comprising the sort handle and the extracted records. The intermediate information module may be configured to truncate or otherwise shorten the sort handle to meet log record size criteria imposed by the operating system.

The sorting module may be configured to sort the extracted log records according to the sort handle. The sorting module may sort the extracted records by utilizing a standard sort utility, for example SYNCSORT or DFSORT, on the sort handle. The sorting module may store the sorted extracted records. The sorting module may be further configured to sort the extracted log records sequentially according to multiple data fields which may be defined by multiple log field labels according to the search criteria.

The record display module may be configured to display the sorted extracted log records. Displaying the records may comprise sending the records to a computer for later access, printing the records, storing the records in an electronic format, and the like. Displaying the records may comprise sending the records to a software program for further processing, wherein the records may never be directly displayed to a human user. The record display module may be further configured to remove any sort handle(s) from the sorted extracted records before displaying the records.

A method is disclosed for performing criteria-based grouping and searching of database management system log records. The method may be implemented as a computer program product. The method may begin with a search criteria module interpreting a search criteria. A log map module may then interpret a log record description. The log record description may comprise a log record type data mapping file, which may comprise a set of log record types, a set of log field labels corresponding to the set of log record types, and a set of log field label locations corresponding to each of the set of log field labels.

A record extraction module may then extract a plurality of log records from a set of database management system log records according to the search criteria and the log record data description. An intermediate information module may then generate an intermediate file comprising a sort handle added to the first data column of each extracted record. The sort handle may comprise data from the data field corresponding to the log field label defined by the search criteria for each extracted log record.

A sorting module may then sort the extracted log records according to the search criteria. In one embodiment, the search criteria comprises a plurality of log field labels, and the sorting module sorts the extracted log records sequentially according to each of the plurality of log field labels. A record display module may then remove the sort handle from the sorted extracted records, and may present the sorted extracted log records. Without limitation, the record display module may present the sorted extracted log records to a user, a storage system, and/or a software component.

A method is disclosed to enhance database management system log manipulation. A practitioner may receive search criteria from a director. The practitioner may use a computer to read a log record type data mapping file from a database management system, and to read a database management system log file from the database management system. The practitioner may then execute a log manipulation tool.

The log manipulation tool may comprise a record extraction module, an intermediate information module, and a sorting module. The log manipulation tool may be configured to extract a plurality of log records from the database management system log file according to the search criteria and the log record type data mapping file. The log manipulation tool may be further configured to generate a sort handle from the extracted records, and to sort the extracted records according to the sort handle. The practitioner may then present the sorted extracted log records to the director.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one embodiment of an apparatus for criteria-based grouping and searching of database records in accordance with the present invention;

FIG. 2 is a schematic block diagram depicting one embodiment of a system for enhancing database management system log manipulation in accordance with the present invention;

FIG. 3A is a schematic block diagram depicting one embodiment of a search criteria in accordance with the present invention;

FIG. 3B is a schematic block diagram depicting an alternative embodiment of a search criteria in accordance with the present invention;

FIG. 4 is a schematic block diagram depicting one embodiment of a log record description in accordance with the present invention;

FIG. 5 is a schematic block diagram depicting one embodiment of a log record type data mapping file in accordance with the present invention;

FIG. 6 is a schematic block diagram depicting one embodiment of a database management system log file in accordance with the present invention;

FIG. 7A is an illustration of one embodiment of intermediate information in accordance with the present invention;

FIG. 7B is an illustration of one embodiment of sorted extracted records in accordance with the present invention;

FIG. 8 is an illustration of an alternative embodiment of sorted extracted records in accordance with the present invention;

FIG. 9 is a schematic flow chart illustrating one embodiment of a method to perform criteria-based grouping and searching of database management system log records in accordance with the present invention; and

FIG. 10 is a schematic flow chart illustrating one embodiment of a method to enhance database management system log manipulation in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer programmed product may take any form capable of generating a signal, causing a signal to be generated, or causing execution of a program of machine-readable instructions on a digital processing apparatus. A computer programmed product may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

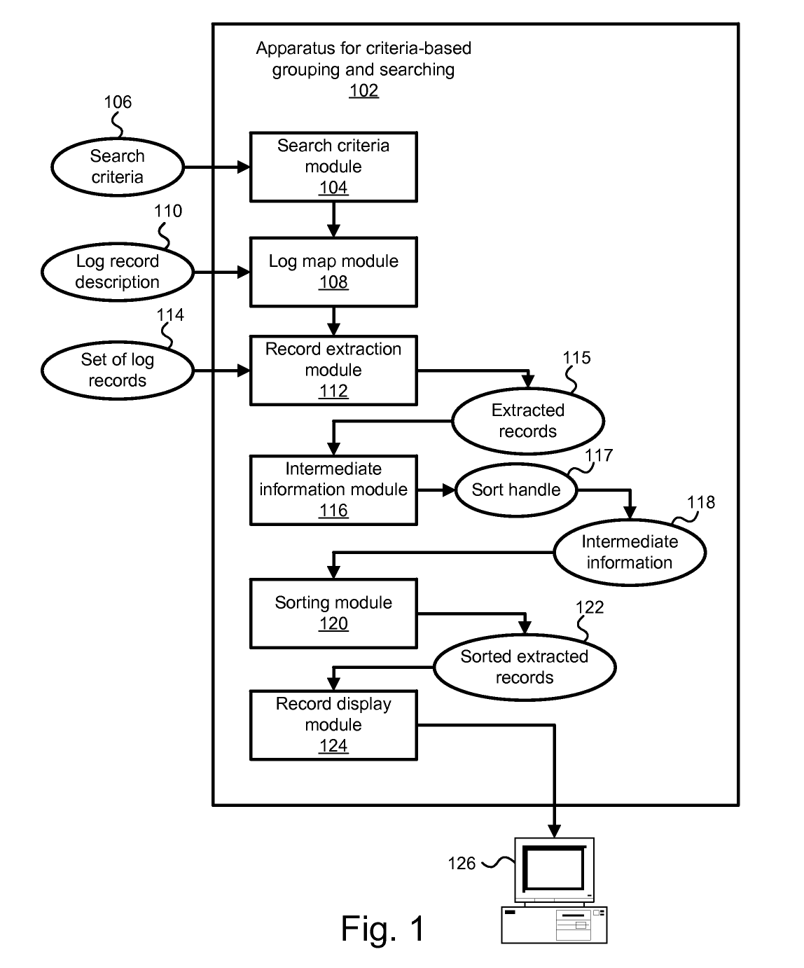

FIG. 1 is a schematic block diagram depicting one embodiment of an apparatus 102 for criteria-based grouping and searching of database records in accordance with the present invention. The apparatus 102 may comprise a number of modules configured to functionally execute the operations of criteria-based grouping and searching of database records. In one embodiment, the apparatus 102 may comprise a search criteria module 104, a log map module 108, a record extraction module 112, an intermediate information module 116, a sorting module 120, and a record display module 124.

The search criteria module 104 may be configured to interpret search criteria 106. The search criteria 106 may comprise a log field label, for example “Group name”. In one embodiment, the search criteria 106 may indicate that the records of interest comprise records containing a field with a label equal to the search criteria 106. A log field label may comprise an active resource, for example a resource being accessed or used at the time when a log record is stored. A log field label may comprise an event which caused the log record to be generated. The event may comprise a transaction, an exception condition, a security event, or the like. The log field label identifies the type of resource or event. The value for the log field identifies a specific resource or event involved in the particular log record. A variety of log field labels may be used including a database name, a program name, a transaction name, or a user name. The values in these associated fields are specific instances of those types. In one embodiment, the log field label may comprise a recovery token, wherein an application operating on a system may be configured to set and clear the recovery token at various operating stages of the application.

The log records may be formatted differently than shown in the present examples. The particular resources, events, or other data may vary in certain applications, and field locations and names may vary. The included examples are illustrative and not intended to limit the scope of the invention.

In a further embodiment, the search criteria 106 may also indicate that the records of interest should be sorted according to the field indicated by the search criteria 106. For example, if the search criteria 106 is “Group name,” the search criteria module 104 may interpret the search criteria 106 such that the apparatus 102 will extract records comprising a data field “Group name,” and the apparatus 102 may sort the records according to the values in the “Group name” data field.

In one embodiment, the search criteria 106 may further comprise a partial log field label, multiple log field labels, a log field label with a partial value, and combinations thereof. For example, the search criteria 106 may comprise a log field label “Group*” where * may be a wild card character. In another example, the search criteria 106 may comprise “Group name, Program name.” In another example, the search criteria 106 may comprise “Group name, soft*.” The included fields and information may be adjusted to meet a size limitation on data records that may be imposed by the system in question.

The log map module 108 may be configured to interpret a log record description 110, which may be a data map. The log record description 110 may comprise at least one log record type, a set of log field labels corresponding to each log record type, and a set of log field label locations corresponding to each of the set of log field labels. The log record description 110 may be a file comprising a set of log record types, a set of log field labels corresponding to each of the set of log record types, and a set of data field locations corresponding to each of the set of log field labels.

The log record type may comprise a metadata identifier for a category of log records, wherein the category of log records may comprise identical log field labels and log field label locations. The log record type may be known as a log record class, or similar concept, and an individual log record may be known as an instance of the log record type. The set of log records may comprise a set of database management system log records.

The set of log field labels corresponding to each log record type may comprise a list of log field labels associated with a log record type. For example, a log record type of “Payroll record” may comprise a list of log field labels such as “Employee number,” “Gross pay,” “Federal income tax withholding,” and so forth. In an alternative embodiment, the set of log field labels corresponding to each log record type may comprise a list of log field labels, with a list of associated log record types corresponding to each log field label. For example, one member of the set of log field labels may be “Employee number,” and the list of associated log record types may comprise “HR record,” “Payroll record,” “Vacation request,” and “Incident record.” Many organizations of the set of log field labels corresponding to each log record type are possible, and all are contemplated within the scope am of the present invention.

The set of log field label locations corresponding to each of the set of log field labels may comprise a data position associated with a log record type wherein a given log field label can be located. For example, the log field label “Employee number” may be found beginning at the 6^{th} byte of the log record type “Incident record,” and may extend for 4 bytes. The set of log field label locations may be expressed as a set of length and offset values, they may be relative to the end or the beginning of a log record, and they may comprise information to calculate the location at run-time due to variable-length data fields which may occur in some database systems. In one embodiment, the set of log field label locations corresponding to each of the set of log field labels may comprise a field number. For example, the data field “Employee number” may comprise the second field of the log record type “Incident record.”

The record extraction module 112 may be configured to extract a plurality of log records 115 from a non-homogeneous set of log records 114 according to the search criteria 106 and the log record description 110. In one embodiment, the record extraction module 112 may be configured to extract log records 115 having a data field with a label equivalent to the search criteria 106 according to the log record description 110. For example, if the search criteria 106 is “Group name,” the record extraction module 112 may be configured to identify all log record types comprising a data field “Group name” according to the log record description 110, and the record extraction module 112 may be further configured to extract all log records 115 from the set of log records 114 of the identified log record types. The record extraction module 112 may be a tool such as DFSERA10, or a similar record selection and extraction tool.

In a further example, the search criteria 106 may be “Group*,” and the record extraction module 112 may be configured to identify all log record types comprising a log field label that begins with “Group.” In a further example, the search criteria 106 may be “Group name, Program name,” wherein the record extraction module 112 may be configured to identify all log record types comprising a log field label “Group name” and a log field label “Program name.” It is within the skill of one in the art to build various logic around the search criteria 106 to allow multiple search criteria 106 to be combined in an AND, OR, NOR, NOT, XOR, etc. fashion for various embodiments of the invention.

In a further example, the search criteria 106 may be “Group name, soft*,” wherein the record extraction module 112 may be configured to identify all log record types comprising a log field label “Group name,” and to extract all log records from the set of log records 114 comprising one of the identified log record types and a value in the log field labeled “Group name” beginning with “soft.” In the example, the record extraction module 112 will extract a log record of a type having a log field label “Group name” and a group name of “Software development,” but may not extract a log record of a type having a log field label “Group name” and a group name of “Human resources.” Various features to allow multiple search criteria 106 to be marked as log field labels and values, as well as allowing search logic are within the skill of one in the art and contemplated within the scope of the invention.

The intermediate information module 116 may be configured to generate a sort handle 117 configured to allow a sorting utility to sort the extracted log records according to the sort handle 117. For example, the intermediate information module 116 may be configured to add a data field to the beginning of each of the extracted records 115, wherein the data field comprises the data values corresponding to the log field labeled according to the search criteria 106. Where the search criteria 106 identifies multiple data fields, the intermediate information module 116 may be configured to insert multiple data fields at the beginning of the extracted records 115, to concatenate information from the multiple data fields and insert the concatenated information into a single inserted data field, or use similar methods to enable sorting the extracted records 115 according to the search criteria 106. The intermediate information module 116 may be further configured to append the sort handle 117 to the extracted records 115, for example as the first data field in the extracted records 115. The sort handle 117 may also be appended at the end of the extracted records 115, or at a known location (e.g. beginning with the 12^{th} bit) within the extracted records 115.

In one embodiment, the intermediate information module 116 maybe further configured to generate a sort handle 117 comprising a time stamp corresponding to each of the extracted log records 115. The intermediate information module 116 may be further configured to insert the sort handle 117 as the first and second data fields in the extracted records 115, the first field comprising the data values corresponding to the log field labeled according to the search criteria 106, and the second field comprising the time stamp corresponding to the extracted log record 115. The time stamp field may be located at an offset of 16 bytes from the end of the record 115.

The intermediate information module 116 may be further configured to generate intermediate information 118 which may comprise the extracted records 115 with the sort handle 117 added as a first data field to each of the extracted records 115. The intermediate information 118 may comprise and intermediate file, a data array in memory, or similar components. The intermediate information module 116 may be configured to truncate or otherwise shorten the sort handle 117 such that the records of the intermediate information 118 do not exceed a size limit. In one embodiment, the records of the intermediate information 118 are adjusted such that they do not exceed a length of 32,752 byes. In a further embodiment, the intermediate information module 116 may be configured to edit the records to increment an LL field (a length field) to indicate the new length of the record with the sort handle 117.

The sorting module 120 may be configured to sort the extracted log records 115 according to the search criteria 106. The sorting module 120 may sort the extracted records 115 by utilizing a standard sort utility, for example SYNCSORT or DFSORT, on the sort handle 117. The sorting module 120 may store the sorted extracted records 122. The sorting module 120 may be further configured to sort the extracted log records 115 sequentially according to multiple data fields which may be defined by multiple log field labels according to the search criteria 106.

The record display module 124 may be configured to display the sorted extracted log records 122. Displaying the records 122 may comprise sending the records to a computer 126 for later access, printing the records 122, storing the records 122 in an electronic format, and the like. Displaying the records 122 may comprise sending the records 122 to a software program for further processing, wherein the records 122 may never be directly displayed to a human user. The record display module 124 may be further configured to remove any sort handle(s) 117 from the sorted extracted records 122 before displaying the records 122.

In one embodiment, the intermediate information module 116 may be configured to insert a key length parameter into a control statement file (not shown). The display module 124 may be configured to read the key length parameter and determine the size of the inserted sort handle 117 based on the key length parameter. The display module 124 may be further configured to remove the sort handle(s) 117 based on the key length parameter, and to decrement an LL field to indicate the restored length of each record.

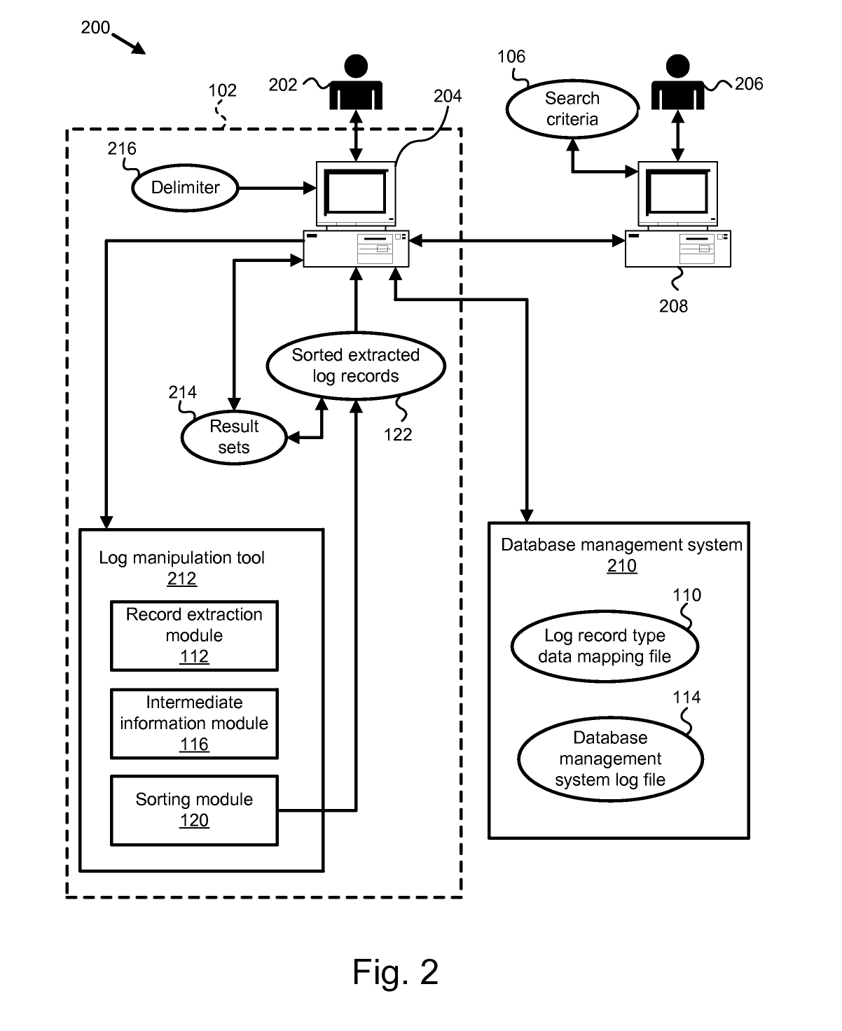

FIG. 2 is a schematic block diagram depicting one embodiment of a system 200 for enhancing database management system log manipulation in accordance with the present invention. The system may comprise a practitioner 202 who may use a first computer 204. The practitioner 202 may interpret at least one search criteria 106, which may be provided by a director 206 who may use a second computer 208 to communicate the search criteria 106 to the practitioner. Other means of communicating the search criteria 106 may be used, including without limitation communicating the search criteria 106 by phone. In one embodiment, the director 206 and the practitioner 202 may comprise the same entity. For example, a customer (not shown) may communicate a problem related to a database management system 210 to a practitioner 202, and the practitioner 202 may act as a director 206 and determine search criteria 106 which may be appropriate to diagnose the problem communicated by the customer.

The practitioner 202 may interpret a log record data description, which may be a log record type data mapping file 110, where the log record data description may comprise at least one log record type, a set of log field labels corresponding to each of the at least one log record types, and a set of log field label locations corresponding to each of the set of log field labels. The practitioner 202 may interpret the log record data description by reading a log record type data mapping file 110 from a database management system 210 using the first computer 204. The practitioner 202 may receive a database management system log file 114 by reading the log file 114 from a database management system 210 using the first computer 204.

The practitioner 202 may execute a log manipulation tool 212 comprising modules configured to functionally execute the operations of the log manipulation tool 212. In one embodiment, the modules of the tool 212 may comprise a record extraction module 112, an intermediate information module 116, and a sorting module 120. The record extraction module 112 may be configured to extract a plurality of log records 115 from the database management system log file 114 according to the search criteria 106 and the log record type data mapping file 110. The intermediate information module 116 may be configured to generate a sort handle 117, where the sort handle 117 is configured to allow a sorting utility to sort the extracted log records 115 according to the search criteria 106. The sorting module 120 may be configured to sort the extracted log records 115 according to the search criteria 106, and to provide sorted extracted log records 122. The practitioner 202 may present the sorted extracted log records 122 to the director 206 in an electronic or hard copy format.

The sorting module 120 may be further configured to divide the sorted extracted log records 122 into a plurality of result sets 214, wherein each result set 214 of the sorted extracted log records 122 comprises a unique data result based on the search criteria 106. For example, if the search criteria 106 were “Group name,” then each result set 214 may represent a set of all log records related to each “Group name” within the database management system log file 114. In the example, if six groups are found in the database management system log file 114, with names “Group 1” through “Group 6,” then the sorting module 120 may separate the sorted extracted log records 122 into six result sets 214, with each result set 214 corresponding to one of “Group 1” through “Group 6.” The sorting module 120 may be further configured to insert a delimiter 216 between each result set 214, and the practitioner 202 may present the sorted extracted log records 122 with the inserted delimiters 216.

The system 200 may comprise an apparatus 102 for criteria-based grouping and searching of database management system log records 114. The apparatus 102 may comprise and/or communicate with the first computer 204. In one embodiment, the first computer 204 comprises a search criteria module 104, a log map module 108, a record extraction module 112, and a record display module 124. The various modules of the apparatus 102 may be computerized or not, and the computers may be distributed or combined. For example, in one embodiment the functions of the search criteria module 104 may be performed manually by the practitioner 202, and the functions of the log map module 108 and record extraction module 112 may be performed by the first computer 204.

The first computer 204 may be a standalone computer used by the practitioner 202, and the log manipulation tool 212 may be a program located on the first computer 204 or in communication with the first computer 204. The first computer 204 may be part of a computer server, and may be on the same computer as the database management system 210.

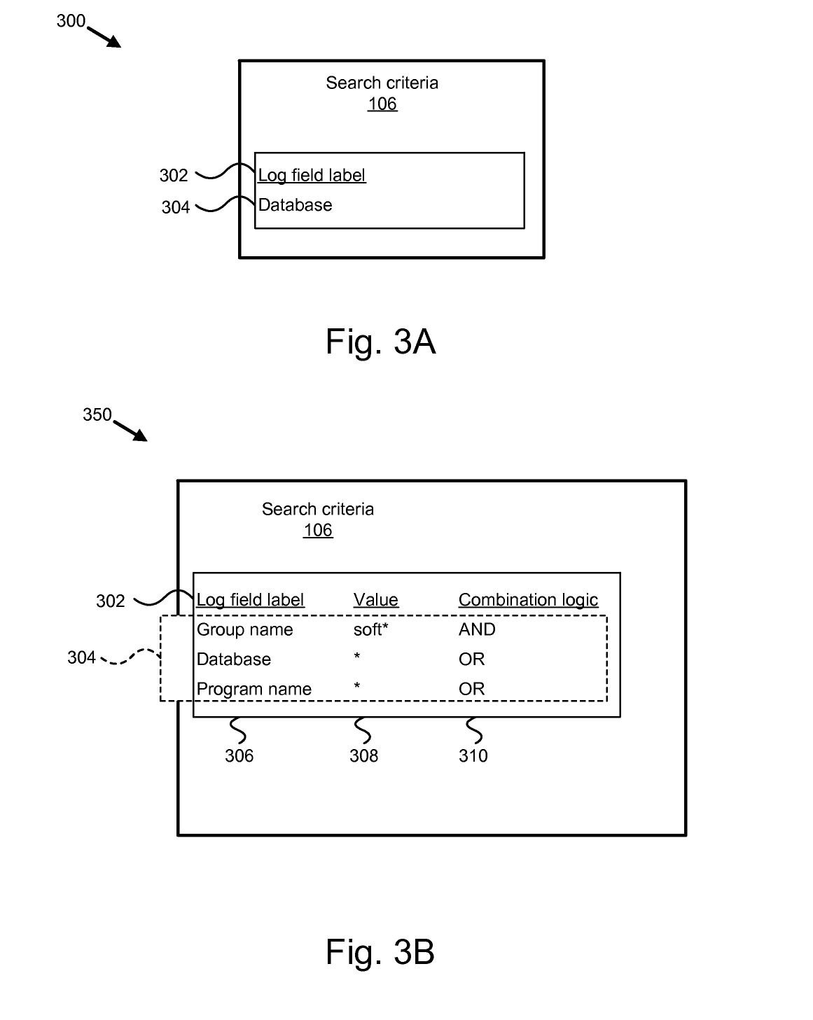

FIG. 3A is a schematic block diagram depicting one embodiment of a search criteria 106 in accordance with the present invention. The search criteria 106 may comprise a heading 302 and a value 304. The heading 302 in the example embodiment comprises “Log field label” and the body 304 in the example comprises “Database.” In one embodiment, the record extraction module 112 may use the search criteria 106 from FIG. 3A to extract log records comprising a log record type containing a log field labeled “Database” from a set of log records 114.

FIG. 3B is a schematic block diagram depicting an alternative embodiment of a search criteria 106 in accordance with the present invention. The search criteria 106 may comprise at least one heading 302 and at least one value 304. The headings 302 in the example embodiment comprise “Log field label,” “Value,” and “Combination logic.” The values 304 in the example embodiment comprise “Group name soft* AND,” “Database * OR,” and “Program name * OR.” In one embodiment, the record extraction module 112 may use the search criteria 106 from FIG. 3B to extract log records from a set of log records 114, wherein the extracted log records 115 comprise a log record type containing a log field labeled either “Database” or “Program name,” and a log field labeled “Group name” further containing a value beginning with “soft” in the “Group name” field.

Therefore, in the embodiment of FIG. 3B, the search criteria 106 comprises at least one log field label 306, a plurality of data values 306 corresponding to the log field labels 306, and a plurality of combination logic values 310 corresponding to the log field labels 306, and the record extraction module may be configured to extract a plurality of log records from a set of log records 114 such that the extracted records 115 include data fields corresponding to the log field labels 306 to satisfy the plurality of combination logic values 310, and the extracted records 115 may comprise values within the extracted record data fields to satisfy the data values 308 corresponding to the log field labels 306.

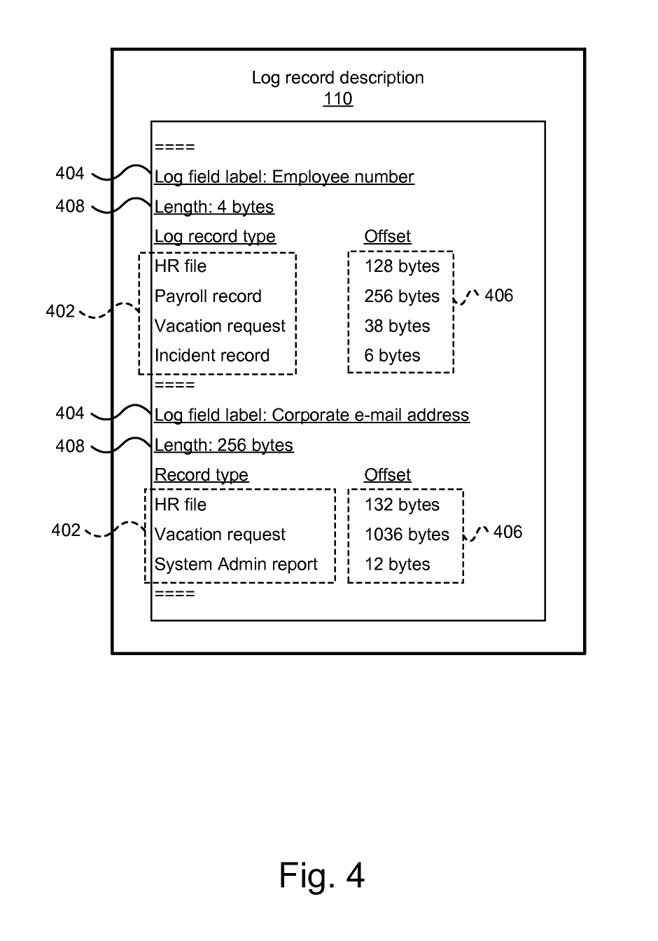

FIG. 4 is a schematic block diagram depicting one embodiment of a log record description 110 in accordance with the present invention. The log record description may comprise at least one log record type 402, a set of log field labels 404 corresponding to each of the at least one log record types 402, and a set of log field label locations 406, 408 corresponding to each of the set of log field labels 404. The set of log field label locations may comprise a data field length 406 associated with the log field label 404, and a data field offset 408 associated with each of the at least one log record types 402.

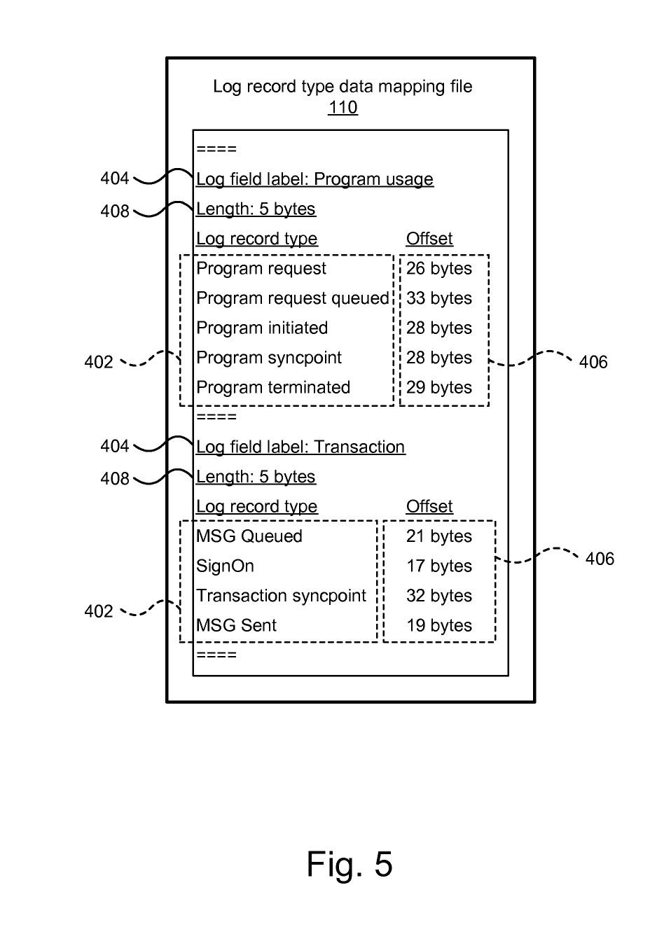

FIG. 5 is a schematic block diagram depicting one embodiment of a log record type data mapping file 110 in accordance with the present invention. The log record type data mapping file 110 may comprise at least one log record type 402, a set of log field labels 404 corresponding to each of the at least one log record types 402, and a set of log field label locations 406, 408 corresponding to each of the set of log field labels 404 the set of log field label locations may comprise a data field length 406 associated with the log field label 404, and a data field offset 408 associated with each of the at least one log record data types 402.

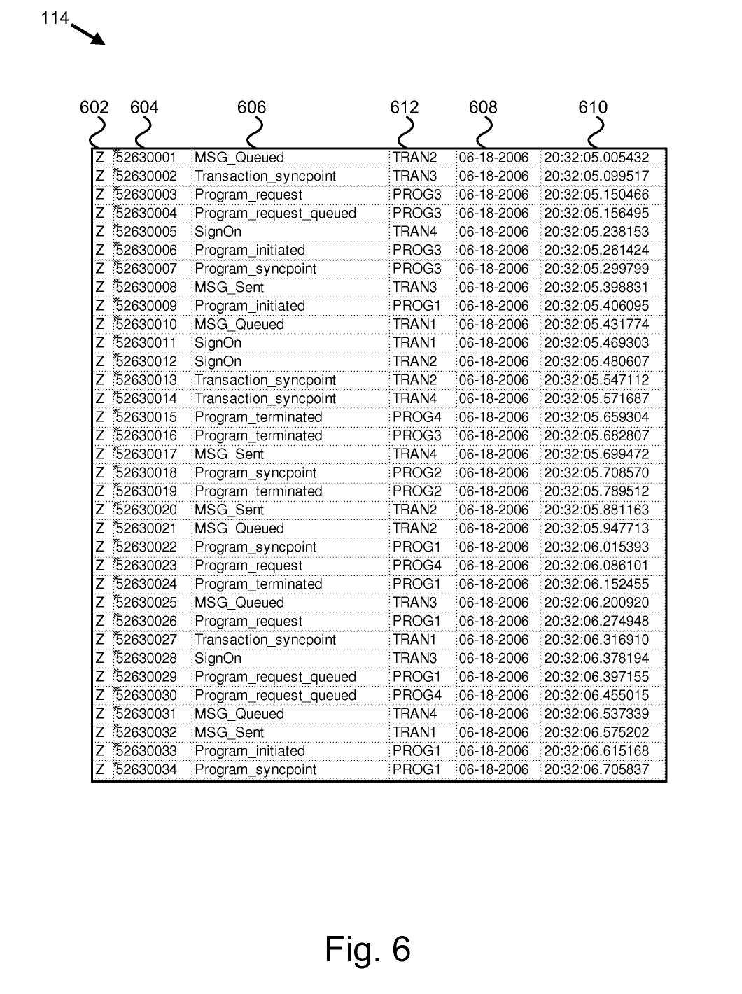

Note the difference between the log field label 404 and the actual data value. For example, a log field label 404 may be “Program usage” indicating a log record of a program usage event. The actual data value may be 5 bytes long (408), and offset 406 by 26 bytes when the log record type 402 is a “program request.” Referring to FIG. 6, the third log record is of a log record type 606 of “Program-request,” the data value is in the data field 612, offset by 26 bytes and occurring over 5 bytes. The system log file 114 of FIG. 6 is consistent with a log file 114 constructed according to the log record description 110 of FIG. 5.

FIG. 6 is a schematic block diagram depicting one embodiment of a database management system log file 114 in accordance with the present invention. The database management system log file 114 may comprise a plurality of data fields. The data fields in the embodiment of FIG. 6 are illustrated as distinctly separated for illustration, but the data within the database management system log file 114 may be stored as a single string of data, in a relational database, or in any other method known in the database art. To maintain a continuing illustration, the database management system log file 114 is consistent with the log record data type mapping file 110 shown in FIG. 5.

In one embodiment, the database management system log file 114 may comprise a leading character 602, a log entry identification number 604, a log record type 606, a date stamp 608, and a time stamp 610. The records within the database management system log file 114 need not have the same data fields, or data fields in the same order. In the example of FIG. 6, the data field 612 comprises a log field label 404 “Program usage” for those log entries of a log record data type 606, 402 associated with “Program usage” as illustrated in FIG. 5, while the data field 612 comprises a log field label 404 “Transaction” for those log entries of a log record data type 606, 402 associated with “Transaction” as illustrated in FIG. 5.

For clarity in FIG. 6, the “Transaction” data fields have values beginning with “TRAN” while the “Program usage” data fields have values beginning with “PROG.” The actual values may be defined in the log record data type mapping file 110, and the naming convention in the example does not limit or suggest any naming convention for an actual embodiment of the invention.

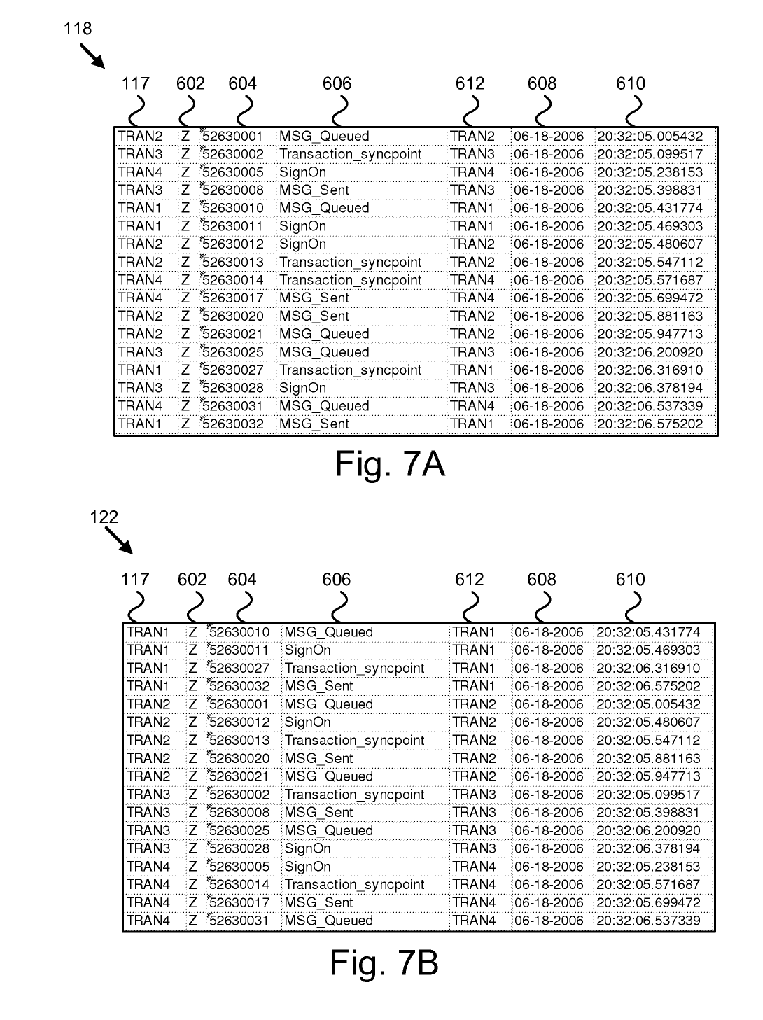

FIG. 7A is an illustration of one embodiment of intermediate information 118 in accordance with the present invention. The intermediate information 118 shown in FIG. 7A is consistent with a record extraction module 112 extracting log records from the database management system log file 114 illustrated in FIG. 6, according to the log record data type mapping file 110 illustrated in FIG. 5, and according to a search criteria 106 comprising a log field label “Transaction.”

In the example of FIG. 7A, the record extraction module 112 extracted the log records comprising a log record type 606 associated with the log field label “Transaction,” and the intermediate information module 116 appended a sort handle 117 to the first data column of each of the extracted records 115. The sort handle 117 in the example comprises data from the data field location 406, 408 corresponding to the log field label defined by the search criteria 106 for each extracted log record 115. As shown in the illustration of FIG. 7A, the intermediate information module 116 copied the data from the data field 612 to the sort handle 117, such that a standard search utility can now sort the log records according to the sort handle 117.

FIG. 7B is an illustration of one embodiment of sorted extracted records 122 in accordance with the present invention. The sorted extracted records 122 shown in FIG. 7B are consistent with a sorting module 120 sorting by the sort handle 117 from FIG. 7A according to the search criteria 106. In one embodiment, the sorting module 120 may sort by the sort handles 117 by operating a standard search tool on the intermediate information 118 and sorting by the sort handle 117. The sort may be an alphabetical sort based on the sort handle 117. Other sort organizations are possible, for example a chronological sort.

Note that, in one embodiment, the transaction log entries in FIG. 7B may represent multiple occurrences of a transaction. For example, the transaction “TRAN2” may first occur at the example time “20:32:05.005432” with the log record type 606 “MSG_Queued.” The next three log entries for “TRAN2” may be associated with the first occurrence of “TRAN2” within the time frame covered by the log file 110 excerpt of the example in FIG. 7B. The log entry “MSG_Queued” at example time “20:32:05.947713” may be for a second occurrence of the transaction “TRAN2” within the time frame covered by the log file 110 excerpt of the example in FIG. 7B.

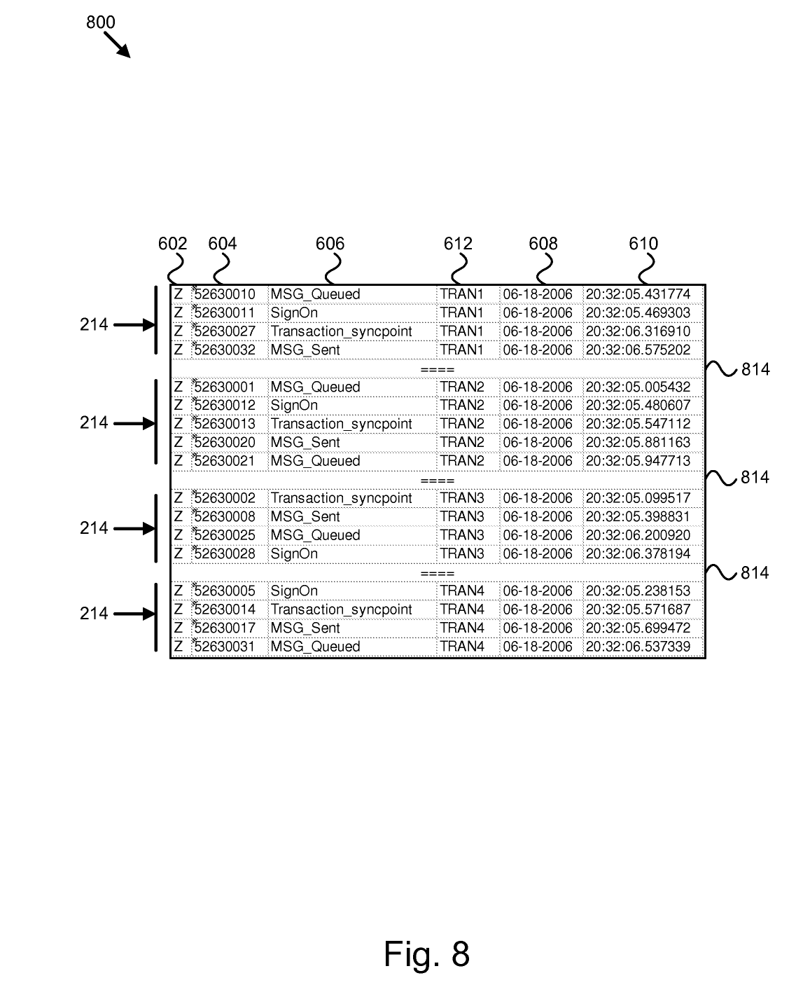

FIG. 8 is an illustration of an alternative embodiment of sorted extracted records 122 in accordance with the present invention. In the example embodiment of FIG. 8, the record display module 124 is further configured to remove the sort handle 117 from each of the sorted extracted log records 122, and to insert a delimiter 814 between each of a plurality of result sets 214. The example shown in FIG. 8 is consistent with the record display module 124 removing the first data field 714 from sorted extracted log records 122 from FIG. 7B. In one embodiment, each result set 214 comprises a unique data result based on the search criteria 106. In the example shown in FIG. 8, each result set 214 comprises the records corresponding to each unique value of the data field 612.

The schematic flow chart diagrams herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

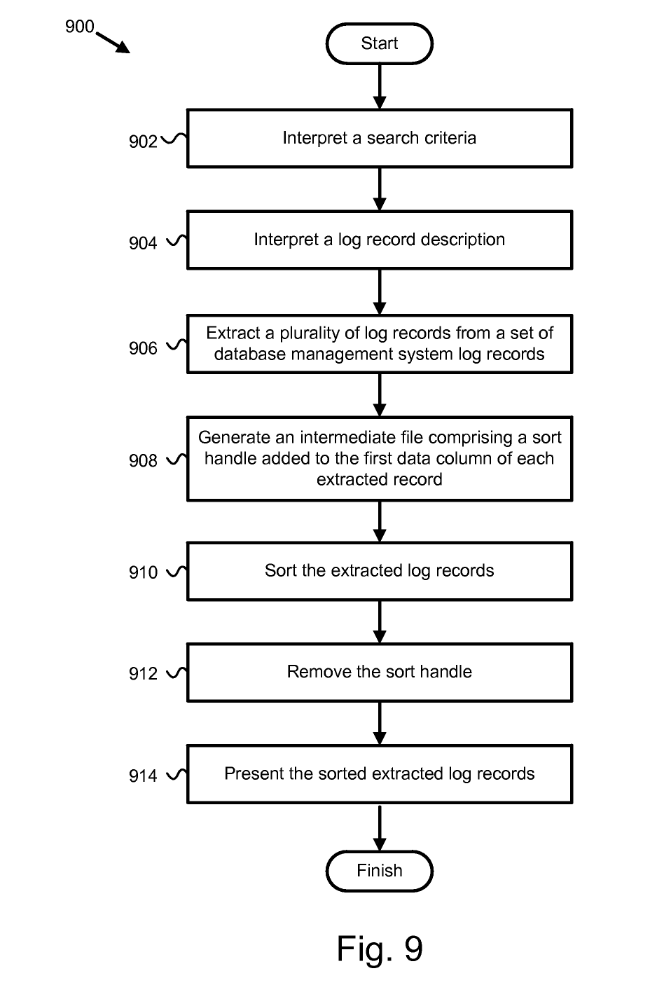

FIG. 9 is a schematic flow chart illustrating one embodiment of a method 900 to perform criteria-based grouping and searching of database management system log records 114 in accordance with the present invention. The method 900 may begin with a search criteria module 104 interpreting 902 a search criteria 106. A log map module 108 may then interpret 904 a log record data description 110. The log record data description 110 may comprise a log record type data mapping file 110, which may comprise a set of log record types 402, a set of log field labels 404 corresponding to the set of log record types 402, and a set of log field label locations 406, 408 corresponding to each of the set of log field labels 404.

A record extraction module 112 may then extract 906 a plurality of log records from a set of database management system log records 114 according to the search criteria 106 and the log record data description 110. An intermediate information module 116 may then generate 908 an intermediate file 117 comprising a sort handle 714 appended to each extracted record 115. The sort handle 714 may comprise data from the data field corresponding to the log field label defined by the search criteria 106 for each extracted log record 115.

A sorting module 120 may then sort 910 the extracted log records 115 according to the search criteria 106. In one embodiment, the search criteria 106 comprises a plurality of log field labels, and the sorting module 120 sorts the extracted log records sequentially according to each of the plurality of log field labels. A record display module 124 may then remove 912 the sort handle 714 from the sorted extracted records 122, and may present 914 the sorted extracted log records 122. Without limitation, the record display module 124 may present 914 the sorted extracted log records 122 to a user, a storage system, and/or a software component.

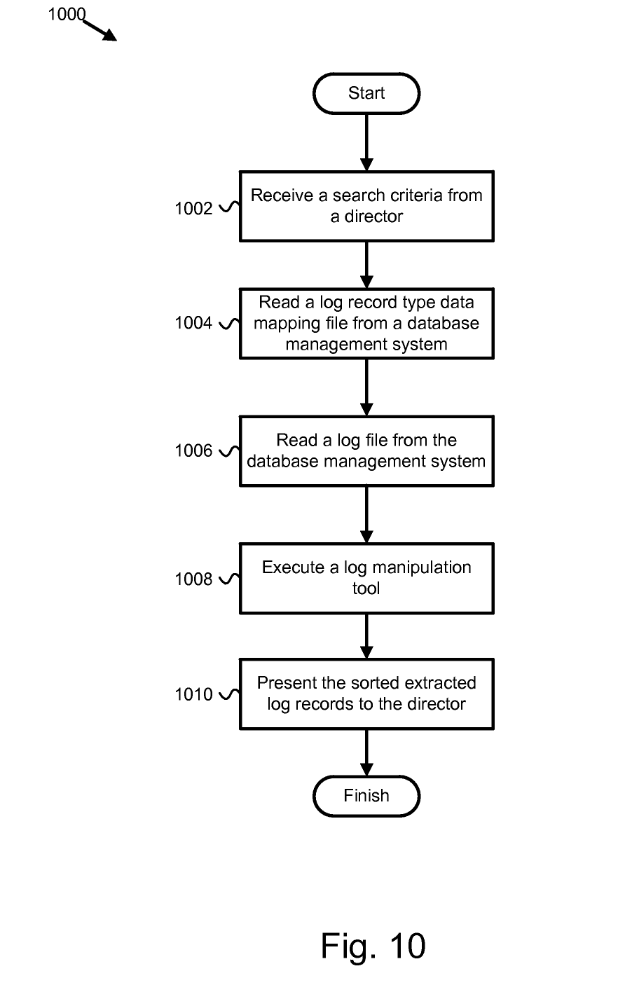

FIG. 10 is a schematic flow chart illustrating one embodiment of a method 1000 to enhance database management system log manipulation in accordance with the present invention. A practitioner 202 may receive 1002 a search criteria 106 from a director 206. The practitioner 202 may use a computer 204 to read a log record type data mapping file 110 from a database management system 210, and to read a database management system log file 114 from the database management system 210. The practitioner 202 may then execute 1008 a log manipulation tool 212.

The log manipulation tool 212 may comprise a record extraction module 112, an intermediate information module 116, and a sorting module 120. The log manipulation tool 212 may be configured to extract a plurality of log records from the database management system log file 114 according to the search criteria 106 and the log record type data mapping file 110. The log manipulation tool 212 may be further configured to generate a sort handle 117 from the extracted records 115 based on the search criteria 106, and to sort the extracted records 115 according to the sort handle 117. The log manipulation tool 212 may be further configured to remove the sort handle 117 from the extracted records 115. The practitioner 202 may then present 1010 the sorted extracted log records 122 to the director 206.

From the foregoing discussion, it is clear that the invention provides a system, method, apparatus for criteria-based grouping and searching of database management system records. The invention also extends the capabilities of criteria-based searching and sorting within database files generally. The invention overcomes previous limitations in the art by allowing a user to search files even where the search criteria occur in different fields with each type of record of the database, and it allows a user to be presented data in a desired format with delimiters if desired.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for criteria-based grouping and searching of log records comprising:
a log map module configured to interpret a log record description comprising at least one log record type, a set of log field labels corresponding to each of the at least one log record types, and a set of log field label locations within a log record corresponding to a log record type;
a search criteria module configured to interpret a search criteria comprising a log field label based on the log record description;
a record extraction module configured to extract a plurality of log records from a set of log records according to the log record description, the extracted log records having a field matching the log field label;
an intermediate information module configured to generate a sort handle for each log record such that a conventional sorting utility can sort the extracted log records according to the values for the log field label, the intermediate information module further configured to associate the sort handle with each extracted log record;
a sorting module configured to sort the extracted log records according to the sort handle;
a record display module configured to display the sorted extracted log records.

2. The apparatus of claim 1, wherein the record display module is further configured to remove the sort handle from each of the sorted extracted log records.

3. The apparatus of claim 1, wherein the intermediate information module is further configured to generate a sort handle such that the size of the log record including the sort handle does not exceed 32752 bytes.

4. The apparatus of claim 1, wherein the conventional sort utility comprises a member selected from the group consisting of SYNCSORT and DFSORT.

5. The apparatus of claim 1, wherein the search criteria further comprises at least one additional log field label, and wherein the sorting module is further configured to sort the extracted log records alphabetically according to the values of the at least one additional log field labels.

6. The apparatus of claim 5, wherein the search criteria further comprises a plurality of data values corresponding to the log field labels, and a plurality of combination logic values corresponding to the log field labels, the record extraction module further configured to extract a plurality of log records from a set of log records such that the extracted records comprise data fields corresponding to the log field labels that satisfy the plurality of combination logic values.

7. The apparatus of claim 1, wherein the sort handle further comprises a time stamp corresponding to each log record.

8. The apparatus of claim 1, wherein the intermediate information module is further configured to generate intermediate information comprising an intermediate file, wherein the intermediate file comprises a sort handle appended to each of the extracted log records, the sort handle comprising a data value corresponding to the log field label defined by the search criteria for each extracted log record.

9. The apparatus of claim 8, wherein the record display module is further configured to remove the sort handle from each of the extracted log records.

10. The apparatus of claim 1, wherein the log field label comprises an active resource.

11. The apparatus of claim 1, wherein the log field label comprises at least one member selected from the group consisting of a database name, a program name, a transaction name, a user name, and a recovery token.

12. The apparatus of claim 1, wherein the log map module is further configured to interpret the log record description by reading a file comprising a set of log record types, a set of log field labels corresponding to each of the set of log record types, and a set of log field label locations corresponding to each of the set of log field labels.

13. A computer program product comprising a computer readable medium having computer usable program code programmed to perform criteria-based grouping and searching of database management system log records, the program product having operations comprising:
interpreting a search criteria comprising a log field label;
interpreting a log record data description comprising at least one log record type, a set of log field labels corresponding to each of the at least one log record types, and a set of log field label locations corresponding to each of the set of log field labels;
extracting a plurality of log records from a set of database management system log records based on the log record data description such that the extracted log records include a field matching the log field label;
generating a sort handle configured to allow a sorting utility to sort the extracted log records, the sort handle including the log field label;
appending the sort handle into each of the extracted log records;
sorting the extracted log records according to the sort handle;
removing the sort handle from each of the extracted log records; and
presenting the sorted extracted log records.

14. The computer program product of claim 13, wherein the search criteria further comprises at least one additional log field label, and the operations further comprise sorting the extracted log records sequentially according to each of the at least one additional log field labels.

15. The computer program product of claim 13, wherein generating a sort handle configured to allow a sorting utility to sort the extracted log records comprises generating an intermediate file comprising a sort handle added to the first data column of each of the extracted log records, the sort handle comprising data from the data field location corresponding to the log field label defined by the search criteria for each extracted log record.

16. The computer program product of claim 15, wherein presenting the sorted extracted log records further comprises removing the sort handle from each of the extracted log records.

17. The computer program product of claim 13, wherein interpreting the log record data description comprises reading a file comprising a set of log record types, a set of log field labels corresponding to each of the set of log record types, and a set of log field label locations corresponding to each of the set of log field labels.

18. A method to enhance database management system log manipulation, the method comprising:
interpreting a search criteria comprising a log field label;
interpreting a log record data description comprising at least one log record type, a set of log field labels corresponding to each of the at least one log record types, and a set of log field label locations corresponding to each of the set of log field labels;
receiving a database management system log file;
executing a log manipulation tool configured to:
extract a plurality of log records from the database management system log file according to the search criteria and the log record data description;
generate a sort handle configured to allow a sorting utility to sort the extracted log records according to the search criteria;
appending the sort handle into each of the extracted log records;
sort the extracted log records according to the search criteria;
removing the sort handle from each of the extracted log records; and
presenting the sorted extracted log records.

19. The method of claim 18, wherein interpreting a search criteria comprises receiving a search criteria from a director.

20. The method of claim 18, wherein presenting the sorted extracted log records further comprises inserting a delimiter between each of a plurality of result sets of the extracted log records, wherein each result set of the extracted log records comprises a unique data result for the log field label.

21. The method of claim 18, wherein interpreting a log record data description comprises reading a log record type data mapping file from a database management system, and wherein receiving a database management system log file comprises communicating with the database management system and reading a log file from the database management system.
